(19) United States
(12) Patent Application Publication
(10) Pub. No.: US 2023/0366773 A1
(43) Pub. Date: Nov. 16, 2023

(54) Method of Estimating Cumulative Damage and Fatigue Strength of a Vibrating Machine

(71) Applicant: Schenck Process Australia Pty Limited, North Ryde NSW (AU)

(72) Inventors: Douglas Robert Teyhan, North Ryde NSW (AU); Jack Woodward, North Ryde NSW (AU); Safa Sultan Qurraie, North Ryde NSW (AU)

(21) Appl. No.: 18/246,550

(22) PCT Filed: Sep. 20, 2021
(86) PCT No.: PCT/AU2021/051085

§ 371 Date: Mar. 24, 2023

(30) Foreign Application Priority Data
Sep. 25, 2020 (AU) 2020903451

(51) Int. Cl. G01M 5/00

(52) U.S. Cl. CPC G01M 5/0041; G01M 5/0066

(57) ABSTRACT

A method of estimating cumulative damage of a vibrating machine with a base and a movable part movable relative to the base including the steps of: providing a computational model which estimates mechanical stress on a portion of the vibrating machine which uses the machine mass, and weight mass and load distribution of feed material, and acceleration to determine the estimated mechanical stress; estimating weight mass and load distribution of feed material; estimating measuring acceleration; providing the mass of the movable part, estimated weight mass and load distribution on the moving part and the estimated acceleration of the moveable part to the model obtaining estimated mechanical stress of the portion of the vibrating machine; recording the estimated mechanical stress of the portion of the vibrating machine over time; and estimating cumulative damage to the portion of the vibrating machine based on two or more successive recorded mechanical stress estimations.

### FIELD OF THE INVENTION

The invention relates to a method of estimating cumulative damage and fatigue strength of a vibrating machine and more specifically, but not exclusively, to a method of estimating cumulative fatigue damage of a vibrating screen, vibrating feeder, or a vibrating conveyor belt.

### BACKGROUND TO THE INVENTION

Vibrating machines are used in many industries. Vibrating screens are used, for example, in the mining industry, along with appropriate screening panels, to separate crushed ore into grades with a consistent and specific particle size. In other industries, screening may, for example, be used for separation of trash, dewatering, draining and rinsing, and/or degritting.

Other forms of vibrating machines include vibrating conveyors and vibrating feeders. Vibrating conveyors and feeders are robust conveying and feeding equipment used for fine to coarse-grained bulk materials such as run of mine, crushed ore, powdery materials, gravel, or coarse scree (being any fragmented or non-fragmented material).

Most vibrating machines have a base, which may remain stationary during operation, and a moving part which is suspended above the base by a mechanical suspension or support system (typically in the form of springs, dampers, and/or hydraulic or pneumatic cylinders) which moves relative to the base. The moving part is subjected to vibrations or oscillations, which periodically accelerates the moving part relative to the base. In some applications acceleration is provided by a vibratory element, also referred to in the industry as an exciter or vibratory motors, which uses unbalanced rotating or reciprocating motive force to accelerate the moving part. In most cases, the exciter is mounted to the moving part itself and in some cases may be mounted to a tuned mass mounted to the moving part itself. In other cases, the relative motion of the moving part may be excited as a result of movement, for example a train car body moving relative to a bogie through a suspension as a result of the train moving along tracks.

A problem with vibrating machines is that the periodic or oscillating movement of the movable part, along with a possible dynamic load thereon, over a period of time can result in fatigue damage to the machine and lead to failure of part or the whole of the substructure of the moving part, the suspension, or the mounting points of the exciter.

Australian patent number 2017359003 in the name of Schenck Process Europe GmbH entitled “Method for operating a state monitoring system of a vibrating machine and state monitoring system” discloses a method for operating a condition monitoring system of a vibrating machine in the form of a vibrating conveyor or a vibrating screen a condition monitoring system. A problem with this disclosure is that it does not assess cumulative damage as part of the state monitoring system or method.

An article by Ramatsetse et al entitled “Failure and sensitivity analysis of a reconfigurable vibrating screen using finite element analysis” published in Case Studies in Engineering Failure Analysis, Volume 9, 2017, Pages 40-51 discloses using finite element analysis (FEA) on a reconfigurable vibrating screen (RVS) to determine whether the structure will perform as desired under extreme working conditions at different configurations. The results of the analysis were used to improve the structure of the RVS. A problem with this disclosure is that it does not evaluate cumulative damage.

### OBJECT OF THE INVENTION

It is accordingly an object of the invention to provide a method of estimating cumulative damage of a vibrating machine which, at least partially, alleviates some of the problems associated with vibrating machines or which provides a useful alternative to existing methods of estimating damage.

### SUMMARY OF THE INVENTION

In accordance with the invention there is provided a method of estimating cumulative damage of a vibrating machine which has a base and a movable part movable relative to the base including the steps of:
providing a model which estimates mechanical stress on a portion of the vibrating machine which uses at least the mass of the moving part, load distribution on the moving part and acceleration of the moving part to determine the estimated mechanical stress;
estimating load distribution on the moving part;
estimating acceleration of the movable part;
providing the estimated load distribution on the moving part and the estimated acceleration of the moveable part as inputs to the model to obtain the estimated mechanical stress of the portion of the vibrating machine;
recording the estimated mechanical stress of the portion of the vibrating machine over time; and
estimating cumulative damage to the portion of the vibrating machine based on two or more successive recorded mechanical stress estimations.

The model may be a computational model and estimate mechanical stress on multiple portions of the vibrating machine.

The load distribution on the moving part may be estimated by estimating mass and distribution of feed material on the physical moving part based on measurement.

The step of estimating the mass and distribution of material on the moving part may be preceded by the step of measuring the distance between the moving part and the base over time at, at least, two points; the measured distances being used to estimate the mass and distribution of material on the moving part.

The distances may be measured by two or more linear displacement transducers or other distance measurement methods.

The movable part may be attached to the base through a suspension or support link

The suspension or support link may be in the form of two or more spring banks.

The distances between the moving part and the base may be measured across the spring banks.

The computational model may include calculating mechanical stress of the portion or portions using geometry of the vibrating machine and the finite element method (FEM).

The portion or portions may be selected by identifying high stress areas under various loading conditions using finite element analysis.

Each identified portion may be selected on whether it is relatively more likely to undergo fatigue failure.

The FEM may take natural frequencies and modal participation of the machine into account in calculating mechanical stress of the portion or portions.

The distribution of material may be simplified as a bias between the actual center of mass of the material and a center of the moving part.

The recorded stresses may be analyzed to extract a cycle count based on stress magnitude for each portion.

Low stress cycles may be filtered from the number of cycles.

The number of cycles may be extracted using the rainflow-counting algorithm.

The cumulative damage to each portion may be calculated according to Miner's rule.

In accordance with a second aspect of the invention, there is provided a method of estimating fatigue strength of a vibrating machine including the steps of: estimating the cumulative damage of portions of the machine as described above; using the cumulative damage estimates to estimate the fatigue strength of the portions of the vibrating machine.

The fatigue strength estimations may be used to improve design of the vibrating machine.

### DETAILED DESCRIPTION

Fatigue is a common mode of failure for many mechanical components which are subjected to repeated fluctuating stresses over time. Peak stresses may be well within design parameters and well beneath the yield or ultimate tensile stress of the material or component, however, repeated and fluctuating stress over time may ultimately cause the component/s to fail. Cumulative damage, as used herein, is a term used in engineering to describe the total permanent fatigue damage to a mechanical component (or part thereof) at a given time as a result of historic stresses exerted on the component and provides a measure of the remaining fatigue life of the component.

Where the nominal operating stress range of a component falls below endurance strength (being the stress below which no fatigue damage will occur), there are two problems with designing a vibrating machine for reliability. Firstly, the loading of the machine is variable, and a co-contribution of worst-case load events can cause stress ranges to exceed the endurance strength of a design resulting in fatigue damage. Secondly, experimentally derived fatigue curves presented by international design standards inadequately describe the design parameters which should be used in the ultra-high-cycle fatigue regime, including the endurance strength, leaving a high degree of uncertainty in fatigue life estimations at the design stage of vibrating machines.

Vibrating machines, such as vibrating screens, vibrating feeders or vibrating conveyors, are especially prone to fatigue failure due to the cyclical, variable, and unpredictable loads induced by vibration and loads. Such machines are often used in heavy industry and downtime caused by such a failure is highly undesirable. A method of estimating cumulative damage of a vibrating machine is described herein wherein such a vibrating machine has a base and a movable part which is movable relative to the base. The calculation of cumulative damage is an estimate of fatigue due to stress and cycles of portions or components of the machine which can give insight to operators as to estimated time to replacement of components and also assist operators to identify characteristics which adversely affect the fatigue life and cumulative damage in order to operate the machine in such a manner that the lifetime of the machine is increased.

The method includes the step of providing a model which estimates mechanical stress of a portion of the vibrating machine. The model will typically be mathematical and computer implemented and will include calculations, simulations, and/or algorithms which uses at least mass of the moving part, load distribution (including mass and distribution of material) on the moving part, and acceleration and frequency of the moving part as inputs and provides the estimated mechanical stress on a portion (or more typically multiple portions) of the vibrating machine. Another optional input, where two or more exciters are used, is asynchronicity or phase difference between these exciters which has an effect on stresses in the machine. The phase difference may be measured by having accelerometers or other sensors (such as a MEMS acceleration sensor or IMU) on each exciter and measuring the time difference between acceleration measurements. The term estimates, as used herein, refer to measurements or, where applicable, to calculations or predictions which are by their very nature approximations to varying degrees.

The inertial load from mass of the moving part is the largest load component acting on the machine. Feed material mass is another critical factor to determine stress as the mass is a significant component of load acting on the machine. Similarly, the feed rate and distribution of material across the moving part will have an impact on the estimated stress on a specific portion. The mass and distribution of material will vary over time. For example, a vibrating screen is typically supplied with feed material (usually fed from a conveyor belt, apron, or vibrating feeder) which feeds the material to the vibrating screen. The material so fed will not be perfectly uniform and distributed across the length and breadth of the feeding system and as such, will not be uniform across the moving part of the screen.

The feed material mass distribution and acceleration are used in the model to calculate the dynamic load on the machine and the method includes the steps of estimating the mass and distribution of feed material and acceleration of the moving part. Acceleration of the moving part is typically measured by one or more accelerometers or MEMS sensors installed on the moving part. Preferably, the accelerometer is a six degree of freedom accelerometer.

The feed material mass and distribution may be estimated in a number of ways. One way of doing so is to monitor the current drawn by a motor of an exciter since the current drawn by the exciter motor will be higher when a greater mass of material is on the moving part. This approach has a drawback in that it is only possible to estimate the mass and not the distribution of the material. Similarly, a belt weighing device may be installed to measure the mass of material being transferred onto the moving part. Again, this approach is only helpful to estimate the mass of material on the moving part and distribution cannot be inferred.

A preferred approach to estimating the mass distribution and bias of the feeding material, is to measure the distance between the moving part and the base at two or more points over time. Preferably, these measurements are taken at four points which are proximate to the corners of the machine. Where the moving part is connected to the base through a support or suspension, typically in the form of spring banks, it is preferable to measure the distance across the spring banks.

The measurement is made by connecting linear displacement transducers across the spring banks of the machine and measuring the distance (or displacement) over time. Since the transducers are typically attached vertically and captured at known time periods, it is possible to derive the velocity and acceleration (at least along the axes of the transducers) which may also be useful in the model.

The spring banks have a known spring coefficient which allows the mass of the material acting on the springs to be calculated from the displacement measurement. Further, as the measurements are made across the spring banks it is possible to estimate the center of mass of the material on the moving part. The difference between center of mass which is calculated and the theoretical center of mass along a specific direction/axis is referred to herein as bias. If an assumption or measurement of the particle size distribution of the material infeed is used, using nominal transport velocities of the feed material across portions of the machine deck and nominal probabilities of particle size grading through the apertures of the deck, it is possible to estimate the infeed tonnage rate of feed material from the measured displacement.

The estimated mass and distribution of feed material, and the acceleration and phase synchronicity are the inputs of the model. The method may include the step of calculating mechanical stress of portions of the machine using the geometry of the machine and the finite element method (FEM). This step may form part of the model or may be used to select portions of the machine which are subject to higher stresses under various load configurations. The FEM may take geometric non-linearity of the vibrating machine design into account in calculating mechanical stress of the portions. If sufficient computational resources are available, the inputs may be provided to the FEM part of the model directly to compute stresses in real time. However, for expedience or where sufficient computational resources are not available, it may be preferable to simplify the model for easier calculation. The simplification may take the form of a multi-dimensional array, or an independent series of calculations (stress calculation algorithms) to calculate stress on a portion of the moving part in relation to the load condition variable. The simplification is essentially an estimation of the FEM estimation and uses mass of the feed material, bias of the material, the acceleration and (where applicable) the phase difference between the exciters to calculate stresses.

The simplified model is created by running multiple FEM simulations using various loading conditions. This takes the form of discrete analysis of the computational model under varying operating characteristics to generate an interpolation matrix of stress versus operating characteristics.

A first set of loading conditions assumes a uniform distribution of material and is run at various feed material loads and the stress of each portion is recorded. This provides a baseline stress under uniform loading. A second set of loading conditions assumes a constant feed mass with varying biases of the material and a third set of loading conditions varies the phase difference between exciters. The baseline stresses are recorded, and the data points are fit to a quadratic curve. The effect of the bias and phase angle on the stress at the portion is recorded as stress multiplier constants and fit to quadratic curves.

This allows the baseline stress, bias multiplier, and phase multiplier to be calculated from quadratic interpolation equations and the resultant stress to be calculated for each portion according to the following formula:

Resultant stress=Baseline stress×(1+Bias multiplier+Phase multiplier)

The formula is simple and requires minimal computing power such that the resultant stress may be calculated for multiple portions multiple times a second.

The method further includes the step of recording the estimated total fatigue stress range, and the number of cycles recorded at each stress range, which is the resultant stress as calculated using the simplified model or the simulated stress calculated according to the FEM, of each portion of the vibrating machine over time.

The recorded stresses may be analyzed to extract the number of cycles into quantised bands according to their associated stress range and peak stress associated with each cycle. The number of cycles and stresses associated with the cycles are used to calculate the cumulative damage to each portion. It is preferable to have the ability to filter out low stress cycles from the calculation in order to eliminate erroneous fatigue damage estimates. The low stress cycles may be filtered based in an assumed endurance limit determined by data analytics or by progressively removing low stress cycles until the predicted remnant service life equals the actual remnant service life. This may require the data analysis to be performed at the point where an analysed portion of the machine fails in service and the remnant service life is known to be zero. The number of cycles may be calculated using signal processing techniques or algorithms such as rainflow-counting which is regularly used in fatigue analysis to determine an approximation of the number of cycles from irregular stress fluctuations.

The cumulative damage is estimated according to existing fatigue life or fatigue damage calculation methods. Most of these calculations take into account the number of cycles and the stress range (or peak stress) of each cycle. One method, known as Miner's rule, estimates cumulative fatigue damage by summing the ratio of number of cycles at a specific stress range to the theoretical cycles to failure at that specific stress range, and provides an estimation of cumulative damage as a proportion of the total fatigue life consumption.

Portions are associated with specific components of the machine and damage to a portion may be attributed to the specific component. This allows a graphical representation of the damage to be provided to an operator. Knowing the cumulative damage of each component allows the operator to plan periodic maintenance and replacement of components as well as to control adverse operating characteristics which would otherwise reduce the service life of the machine without the operator's knowledge. This knowledge will decrease downtime of the machine due to emergency maintenance in the case of unexpected failure.

The method has the additional benefit in that it may be used for optimization analysis for a machine. Where the machine is fed by a conveyor belt or similar means such as an apron feeder, the feed rate from the belt may be measured and changed. Knowing the effect of a given feed rate, usually measured in tons per hour (TPH), on the cumulative damage can allow the calculation of estimates of remaining service life. The feed rate and other process controls, and consequently the output from the machine (provided no breakdowns or failures occur), may be adjusted to optimize the output of the machine. The method is executed continuously through live monitoring of dependent variables of fatigue damage, typically in software as part of an automated continuous monitoring system associated with a vibrating machine and estimates near-real-time cumulative damage based on the fatigue strength and operating stress range of a vibrating machine. By using real-time measurements, the cumulative damage of transient dynamics of start-up and shutdown are also taken into account to the cumulative damage and fatigue life calculations.

Cumulative damage can be a function of many variables, including the measured and estimated quantities described herein, which are unknown to a designer at the time of designing a vibrating machine. The calculated cumulative damage provides an indication of remnant service life to users and operators of a vibrating machine. Operating cycle rates of vibrating machines present challenges for estimation of cumulative damage through direct measurement techniques due to the data density and cycle rates, and in part due to the reliability of the traditional direct measurement techniques in comparison to the service life of the equipment being monitored.

A second aspect of the invention involves using data from the method described above during the design phase of a vibrating machine. This may include a method of estimating fatigue strength of a vibrating machine by estimating the cumulative damage of portions of the machine according to the methods described herein and using the cumulative damage estimates to estimate the fatigue strength of the portions of the vibrating machine. The fatigue strength which has been obtained using these methods will be much more accurate as it has been developed from actual data of vibrating machines in use. Further, where unexpected failure, or repeated unexpected failures, occur on a specific component, it will provide valuable feedback on the model and may be employed to improve the design of the vibrating machine.

It is envisaged that the invention will provide a method of estimating cumulative damage to a vibrating machine in near-real-time without the limitations of direct strain measurement wherein the estimated damage provides valuable feedback to operators of the machine in terms of potential failure, planned maintenance, and optimization of operations.

The invention is not limited to the precise details as described herein. For example, instead of using linear transducers to measure distance between the base and moving part, any other suitable measurement means to measure distance between the base and moving part may be employed.

1. A method of estimating cumulative fatigue damage of a vibrating machine which has a base and a movable part movable relative to the base including the steps of: providing a model which estimates mechanical stress on a portion of the vibrating machine which uses at least the mass of the moving part, load distribution on the moving part, and acceleration of the moving part to determine the estimated mechanical stress; estimating load distribution on the moving part; measuring acceleration of the movable part; providing the mass of the movable part, estimated load distribution on the moving part and the estimated acceleration of the moveable part to the model to obtain the estimated mechanical stress of the portion of the vibrating machine; recording the estimated mechanical stress of the portion of the vibrating machine over time; and estimating cumulative fatigue damage to the portion of the vibrating machine based on two or more successive recorded mechanical stress estimations.

2. The method of claim 1 wherein the model is a computational model and estimates mechanical stress on multiple portions of the vibrating machine.

3. The method of claim 1 wherein the load distribution on the moving part is estimated by estimating mass and distribution of feed material on the moving part.

4. The method of claim 1 wherein the step of estimating the mass and distribution of material on the moving part is preceded by the step of measuring the distance between the moving part and the base over time at, at least, two points; the measured distances being used to estimate the mass and distribution of material on the moving part.

5. The method of claim 4 wherein the step of measuring the distances are measured by two or more linear displacement transducers.

6. The method of any one of claim 1 wherein the movable part is attached to the base through a suspension.

7. The method of claim 6 wherein the suspension is in the form of two or more spring banks.

8. The method of claim 7 wherein the distances between the moving part and the base is measured at the spring banks.

9. The method of claim 1 wherein at least part of the model includes calculating mechanical stress of the portion or portions using geometry of the vibrating machine and the finite element method.

10. The method of claim 1 wherein the portion or portions are selected by identifying high stress areas under various loading conditions using finite element analysis.

11. The method of claim 10 wherein each identified portion is selected as it is part of a component which has relatively lower fatigue service life compared to other components.

12. The method of claim 9 wherein the natural frequencies and modal participation are taken into account in calculating mechanical stress of the portion or portions.

13. The method of claim 9 wherein the distribution of material is simplified as a bias between the actual center of mass of the material relative to a reference location on the moving part.

14. The method of claim 1 wherein the recorded stresses are analyzed to extract a number of cycles and stresses for each portion.

15. The method of claim 14 wherein low stress cycles are filtered from the number of cycles.

16. The method of claim 14 or wherein the number of cycles is extracted using the rainflow-counting algorithm.

17. The method claim 1 wherein cumulative fatigue damage to each portion is calculated according to Miner's rule.

18. A method of estimating fatigue strength of a vibrating machine including the steps of: estimating the cumulative fatigue damage of portions of the machine according to claim 1; and using the cumulative fatigue damage estimates to estimate the fatigue strength of the portions of the vibrating machine.

19. The method of claim 18 wherein the method includes the step of using the fatigue strength estimates to improve the design of the vibrating machine.
